(19) United States
(12) Patent Application Publication
(10) Pub. No.: US 2004/0179944 A1
(43) Pub. Date: Sep. 16, 2004

(54) Rotor end piece

(76) Inventors: Rene Bachofner, Neuenhof (CH); Pietro Grigioni, Oberehrendingen (CH); Wolfgang Kappis, Fislisbach (CH)

Correspondence Address: CERMAK & KENEALY LLP, P.O. BOX 7518, ALEXANDRIA, VA, 22307, US

(21) Appl. No.: 10/792,707

(22) Filed: Mar. 5, 2004

(30) Foreign Application Priority Data
Mar. 11, 2003 (DE) 103 10 431.3

(51) Int. Cl. F03B 3/12

(52) U.S. Cl. 416/219 R

(57) ABSTRACT

The invention relates to a rotor end piece (1) for rotors (2) of thermal turbomachines with circumferential slot (3), consisting of two end piece halves (4, 4′) having side faces (5, 5′) opposite one another in the installed state and top surfaces (6, 6′) adjoining one another. The rotor end piece (1) according to the invention is characterized in that the side faces (5, 5′) of the end piece halves (4, 4′) are connected to one another in a form-fitting manner. To this end, the side faces (5, 5′) are designed in such a way that a dovetail interlocking connection of the two end piece halves (4, 4′) is preferably realized. The interlocked end piece halves are then secured with a weld (8). The firm anchoring of the rotor end piece (1) achieved in this way prevents detachment during operation and damage to the turbomachine caused as a result.

### TECHNICAL FIELD

The invention relates to the field of power plant technology. It relates to a rotor end piece for rotors of thermal turbomachines according to the preamble of patent claim 1 and to a method of fitting the rotor end piece.

### PRIOR ART

Thermal turbomachines, such as turbines and compressors, essentially comprise a rotor fitted with moving blades and a stator in which guide blades are suspended.

The task of the fixed guide blades is to direct the flow of the gaseous medium to be compressed or expanded onto the rotating moving blades in such a way that the energy conversion is effected with the best possible efficiency.

Both moving blades and guide blades essentially have an airfoil and a blade root. In order to be able to fasten the moving blades on the rotor or the guide blades in the stator, slots are recessed in the stator and on the rotor shaft. The roots of the blades are pushed into these slots and locked there.

It is known in the case of compressor rotors having circumferential slots to alternately fit moving blades and intermediate pieces in the rotor recessed portion (circumferential slot) until an opening remains in the circumferential direction, this opening being filled with a “rotor end piece”. This rotor end piece consists of an intermediate piece divided in half (two end piece halves) and of a wedge. To fit the intermediate piece divided in half, a residual opening is required, which is finally closed by pushing in a wedge. The two end piece halves each have a straight side face, which at its top end forms a projecting lobe with the top surface of the end piece half. Said side faces are opposite one another in the installed state, the wedge then being located between them. Once the two end piece halves and the wedge have been installed, the lobes of the two end piece halves are finally caulked via the wedge. This known rotor end piece is supported on the rotor.

A disadvantage with this prior art is that the wedge, on account of the tilting moment of the two end piece halves, which is caused by the centrifugal force during operation, is able to bend open the caulked lobes. The wedge can thus fly out of the compressor and complete compressor damage may occur.

### DESCRIPTION OF THE INVENTION

The aim of the invention is to avoid said disadvantages of the prior art. The object of the invention is to develop a rotor end piece which can be fitted in a simple manner and in which detachment during operation is prevented, so that the occurrence of compressor damage is avoided.

According to the invention, this object is achieved in a rotor end piece for rotors of thermal turbomachines according to the preamble of patent claim 1 in that the side faces of the end piece halves are connected to one another in a form-fitting manner. The two end piece halves preferably have a dovetail interlocking connection at the dividing point.

It is expedient if the two end piece halves are locally welded to one another in the region in which the side faces and the top surfaces adjoin one another.

According to the invention, the object is achieved in the case of a method of fitting the rotor end piece in that the following steps are carried out:

a) in a first step, the first end piece half is inserted into the circumferential slot of the rotor from above,

b) in a second step, this first end piece half is displaced laterally in the circumferential slot until it is anchored in the rotor,

c) in a third step, the second end piece half is fitted next to the already installed first end piece half,

d) in a fourth step, the second end piece half is pushed into the opposite side of the circumferential slot until the first and the second end piece halves are connected to one another in a form-fitting manner, and

e) finally, in a fifth step, the two end piece halves connected in a form-fitting manner are secured by means of a weld in the region in which the side faces and the top surfaces of the end piece halves adjoin one another.

The advantages of the invention consist in the fact that the rotor end piece is firmly anchored in a form-fitting manner in the installed state. In addition, the individual parts of the rotor end piece according to the invention are simple to produce and the fitting is not more complicated compared with the known prior art.

### BRIEF DESCRIPTION OF THE DRAWINGS

An exemplary embodiment of the invention is shown in the drawing, in which:

FIG. 1 shows a side view of a rotor end piece according to the invention for a compressor before installation;

FIG. 2 shows a side view of a rotor end piece according to the invention for a compressor after installation, and

FIGS. 3 a-e show individual steps for fitting the rotor end piece according to the invention according to FIG. 1 into the circumferential slot of the rotor.

In each case the same items are provided with the same designations in the figures. The direction of movement of the parts during installation is designated by arrows.

### Ways of Implementing the Invention

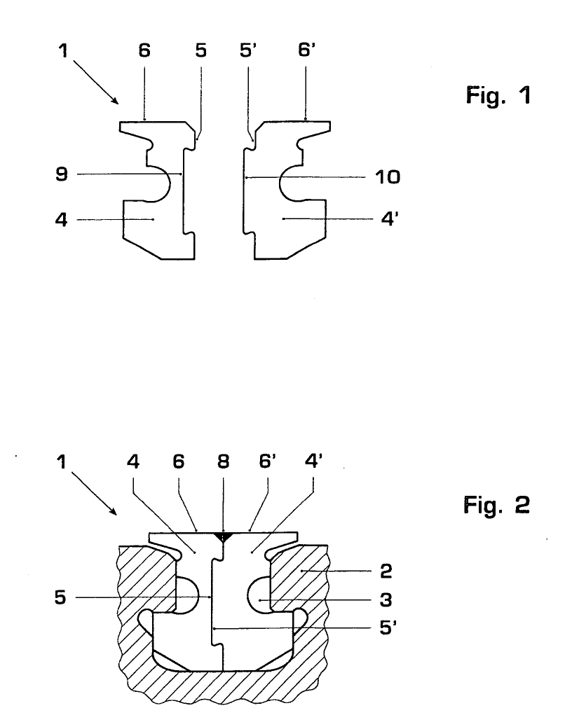

The invention is explained in more detail below with reference to an exemplary embodiment and FIGS. 1 to 3 a-e.

FIG. 1 shows the side view of a rotor end piece 1 according to the invention for a compressor rotor before installation, whereas FIG. 2 shows said rotor end piece 1 after installation in the rotor 2 has been effected.

The rotor end piece 1 according to the invention consists of two end piece halves 4, 4′ with a geometry which is altered compared with the known prior art. Those side faces 5, 5′ of the end piece halves 4, 4′ which are opposite one another in the installed state are designed in such a way that they permit a dovetail interlocking connection of the end piece halves 4, 4′ which is known per se. For this purpose, the first end piece half 4 has a recess 9 in the side face 5, whereas the side face 5′ of the second end piece half 4′ has a projection 10 which fits accurately into this recess 9 (FIG. 1). Joining (interlocking connection) of the two parts 4 and 4′ therefore leads to a form fit (FIG. 2). In order to secure the interlocked end piece halves 4, 4′, a weld 8 is placed in the region in which the side faces 5, 5′ and the top surfaces 6, 6′ of the two end piece halves 4, 4′ adjoin one another.

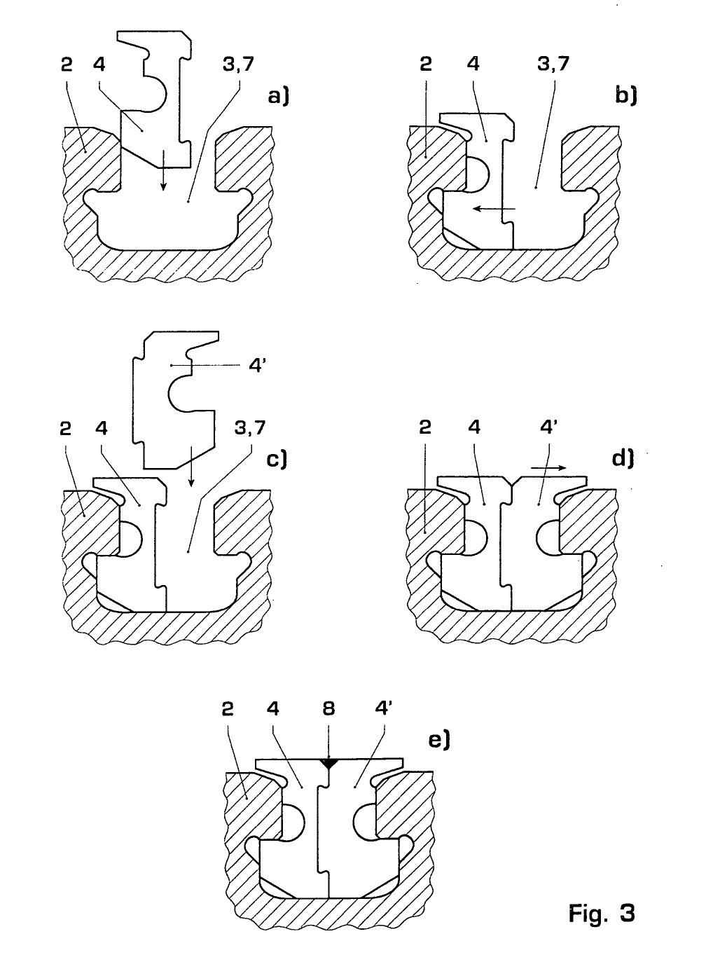

The operation of fitting the rotor end piece 1 is shown in FIGS. 3a to 3e. First of all, all the moving blades and intermediate pieces are fitted into the circumferential slot 3 of the compressor rotor 2 until a residual opening 7 is obtained into which only the rotor end piece 1 consisting of two end piece halves 4, 4′ can be fitted. It is fitted as follows:

The first end piece half 4, in a first step, is inserted into the circumferential slot 3 from above and, in a second step, is displaced laterally in the circumferential slot 3 until it is anchored in the rotor 2. After that, the second end piece half 4′, in a third step, is fitted next to the already installed first end piece half 4 and, in a fourth step, is pushed into the opposite side of the circumferential slot 3 until the two end piece halves 4, 4′ are connected in a form-fitting manner. The two parts 4, 4′ are thus interlocked via the dovetail. Finally, in a fifth step, the two end piece halves 4, 4′ connected in a form-fitting manner are secured by means of a weld 8 in the region in which the side faces 5, 5′ and the top surfaces 6, 6′ of the end piece halves 4, 4′ adjoin one another.

The advantages of the invention consist in the fact that the rotor end piece is firmly anchored in a form-fitting manner in the installed state. This anchoring of the rotor end piece 1 prevents detachment during operation and damage to the turbomachine caused as a result. In addition, the individual parts of the rotor end piece according to the invention are simple to produce, an additional wedge is no longer required, and the fitting is not more complicated compared with the known prior art.

The invention is of course not restricted to the exemplary embodiment described above.

### List of Designations

1 Rotor end piece

2 Rotor

3 Circumferential slot

4, 4′ End piece half

5, 5′ Side face of the end piece half

6, 6′ Top surface of the end piece half

7 Residual opening

8 Weld

9 Recess

10 Projection

1. A rotor end piece (1) for rotors (2) of thermal turbomachines with a circumferential slot (3), consisting of two end piece halves (4, 4′) having side faces (5, 5′) opposite one another in the installed state and top surfaces (6, 6′) adjoining one another, characterized in that the side faces (5, 5′) of the end piece halves (4, 4′) are connected to one another in a form-fitting manner.

2. The rotor end piece (1) as claimed in claim 1, characterized in that the side faces (5, 5′) of the two end piece halves (4, 4′) are connected by means of a dovetail interlocking connection known per se.

3. The rotor end piece (1) as claimed in one of claims 1 to 2, characterized in that the two end piece halves (4, 4′) are locally welded to one another in the region in which the side faces (5, 5′) and the top surfaces (6, 6′) of the two end piece halves (4, 4′) adjoin one another.

4. A method of fitting a rotor end piece (1) as claimed in one of claims 1 to 3 in a residual opening (7) of a circumferential slot (3) of a rotor (2), characterized in that
f) in a first step, the first end piece half (4) is inserted into the circumferential slot (3) from above,
g) in a second step, this first end piece half (4) is displaced laterally in the circumferential slot (3) until it is anchored in the rotor (2),
h) in a third step, the second end piece half (4′) is fitted next to the already installed first end piece half (4),
i) in a fourth step, the second end piece half (4′) is pushed into the opposite side of the circumferential slot (3) until the two end piece halves (4, 4′) are connected in a form-fitting manner, and
j) in a fifth step, the two end piece halves (4, 4′) connected in a form-fitting manner are secured by means of a weld (8) in the region in which the side faces (5, 5′) and the top surfaces (6, 6′) of the end piece halves (4, 4′) adjoin one another.
